(19) United States
(12) Patent Application Publication
(10) Pub. No.: US 2023/0169174 A1
(43) Pub. Date: Jun. 1, 2023

(54) APPARATUS FOR VERIFYING BOOTLOADER OF ECU AND METHOD THEREOF

(71) Applicants: Hyundai Motor Company, Seoul (KR); Kia Corporation, Seoul (KR)

(72) Inventor: Ho Jin Jung, Bucheon (KR)

(21) Appl. No.: 17/811,814

(22) Filed: Jul. 11, 2022

(30) Foreign Application Priority Data
Dec. 1, 2021 (KR) 10-2021-0170271

(51) Int. Cl. G06F 21/57; G06F 21/60; G06F 21/64; G06F 11/36

(52) U.S. Cl. CPC G06F 21/575; G06F 21/602; G06F 21/64; G06F 11/3656

(57) ABSTRACT

Disclosed is an apparatus for verifying a bootloader of an electronic control unit and a method thereof. The apparatus for verifying a bootloader of an electronic control unit includes storage that stores a message authentication code (MAC) for the bootloader of the electronic control unit; and a controller that verifies a digital signature of firmware received from the electronic control unit and when a result of verification for the digital signature is normal, changes the MAC for the bootloader of the electronic control unit.

### CROSS-REFERENCE TO RELATED APPLICATION

This application is based on and claims under 35 U.S.C. § 119(a) the benefit of Korean Patent Application No. 10-2021-0170271, filed in the Korean Intellectual Property Office on Dec. 1, 2021, the entire contents of which are incorporated herein by reference.

### TECHNICAL FIELD

Embodiments of the present disclosure relates to a technique for verifying a bootloader provided in an electronic control unit.

### BACKGROUND

A bootloader provided in an electronic control unit is a kind of program, which initializes a platform, loads firmware of the electronic control unit into processors, and executes the processors to drive the processors together with the loaded firmware.

These bootloaders are stored in persistent memory, such as Electrically Erasable Programmable Read-Only Memory (EEPROM) in production facilities and may be updated in case of problems although frequent updates are not planned. For example, when the electronic control unit supports a new feature, a new bootloader is required for the new feature, and therefore, the bootloader may be updated.

In general, because updating the bootloader of the electronic control unit is a very important process, relevant sufficient verification should be accompanied, but in reality, it is not.

In particular, when the bootloader of the electronic control unit is updated with malicious intent, that is, when the bootloader of the electronic control unit is updated using firmware with malicious code, relevant sufficient verification is not performed, resulting in a possibility that the electronic control unit does not function normally and compromise the safety of vehicle occupants ultimately.

The matters described in this background are prepared to enhance an understanding of the background of the present disclosure and may include matters other than the existing technologies already known to those of ordinary skill in the field to which this technology belongs.

### SUMMARY

An exemplary embodiment of the present disclosure provides an apparatus and method for verifying a bootloader of an electronic control unit which verify a digital signature of firmware received from the electronic control unit when the firmware to which the digital signature is added is loaded into the bootloader of the electronic control unit, and change an MAC (Message Authentication Code) for the bootloader of the electronic control unit when a result of the verification for the digital signature of the firmware is normal to enable the electronic control unit to safely update the bootloader as well as enable normal booting even after the bootloader of the electronic control unit is updated.

The objects of embodiments of the present disclosure are not limited to the above-mentioned objects, and other objects and advantages of embodiments of the present disclosure which are not mentioned may be understood by the following description and will be more clearly understood by embodiments of the present disclosure. It will also be readily apparent that the objects and advantages of the disclosure may be realized by means of the instrumentalities and combinations particularly pointed out in the appended claims.

The technical problems to be solved by embodiments of the present disclosure are not limited to the aforementioned problems, and any other technical problems not mentioned herein will be clearly understood from the following description by those skilled in the art to which embodiments of the present disclosure pertain.

According to an exemplary embodiment of the present disclosure, an apparatus for verifying a bootloader of an electronic control unit includes storage that stores a message authentication code (MAC) for the bootloader of the electronic control unit and a controller that verifies a digital signature of firmware received from the electronic control unit and when a result of verification for the digital signature is normal, changes the MAC for the bootloader of the electronic control unit.

According to an exemplary embodiment, the storage may further store a boot public key for verifying the digital signature of the firmware and information about the bootloader.

According to an exemplary embodiment, the controller may decrypt the digital signature based on the boot public key to extract a first hash value, calculate a second hash value for the bootloader, and when the first hash value is identical to the second hash value, determine that the result of verification for the digital signature is normal.

According to an exemplary embodiment, the controller may calculate the second hash value for the bootloader based on a size and a start address as the information about the bootloader.

According to an exemplary embodiment, the controller may perform update from the MAC for the bootloader before the change stored in the storage to the MAC for the bootloader after the change, when the result of verification for the digital signature is normal.

According to an exemplary embodiment, the controller may maintain the MAC for the bootloader before the change stored in the storage, when the result of verification for the digital signature is abnormal.

According to an exemplary embodiment, the controller may receive the digital signature of the firmware from the electronic control unit when the firmware is loaded into the electronic control unit by a debugging tool.

According to an exemplary embodiment, the debugging tool may add the digital signature to the firmware based on a boot private key.

According to an exemplary embodiment, the debugging tool may include Joint Test Action Group (JTAG).

According to an exemplary embodiment of the present disclosure, a method for verifying a bootloader of an electronic control unit includes storing, by storage, a message authentication code (MAC) for the bootloader of the electronic control unit; and verifying, by a controller, a digital signature of firmware received from the electronic control unit; and changing, by the controller, the MAC for the bootloader of the electronic control unit when a result of verification for the digital signature is normal.

According to an exemplary embodiment, the method may further include storing, by the storage, a boot public key for verifying the digital signature of the firmware and information about the bootloader.

According to an exemplary embodiment, the verifying of the digital signature of the firmware may include decrypting the digital signature based on the boot public key to extract a first hash value, calculating a second hash value for the bootloader, and determining that the result of verification for the digital signature is normal when the first hash value is identical to the second hash value.

According to an exemplary embodiment, the calculating of the second hash value may include calculating the second hash value for the bootloader based on a size and a start address as the information about the bootloader.

According to an exemplary embodiment, the changing of the MAC for the bootloader of the electronic control unit may include performing update from the MAC for the bootloader before the change stored in the storage to the MAC for the bootloader after the change, when the result of verification for the digital signature is normal, and maintaining the MAC for the bootloader before the change stored in the storage when the result of verification for the digital signature is abnormal.

According to an exemplary embodiment, the verifying of the digital signature of the firmware may include receiving the digital signature of the firmware from the electronic control unit when the firmware is loaded into the electronic control unit by a debugging tool.

According to an exemplary embodiment, the receiving of the digital signature of the firmware may include adding, by the debugging tool, the digital signature to the firmware based on a boot private key.

As discussed, the apparatus and methods suitably include use of a controller or processer.

In another aspect, vehicles are provided that comprise an apparatus and/or method as disclosed herein.

### BRIEF DESCRIPTION OF THE DRAWINGS

The above and other objects, features and advantages of embodiments of the present disclosure will be more apparent from the following detailed description taken in conjunction with the accompanying drawings:

FIG. 1 is a configuration diagram of an apparatus for verifying a bootloader of an electronic control unit according to an exemplary embodiment of the present disclosure;

FIG. 2 is a diagram illustrating an example in which an apparatus for verifying a bootloader of an electronic control unit is implemented as a Hardware Security Module (HSM) in the electronic control unit according to an exemplary embodiment of the present disclosure;

FIG. 3 shows an example of a memory configuration of an electronic control unit having an HSM according to an exemplary embodiment of the present disclosure;

FIG. 4 shows an example of a booting process of an electronic control unit having an HSM according to an exemplary embodiment of the present disclosure;

FIG. 5 is a detailed flowchart of a method for verifying a bootloader of an electronic control unit according to an exemplary embodiment of the present disclosure;

FIG. 6 is an overall flowchart of a method for verifying a bootloader of an electronic control unit according to an exemplary embodiment of the present disclosure; and

FIG. 7 is a diagram illustrating a computing system for performing a method for verifying a bootloader of an electronic control unit according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation and can be implemented by hardware components or software components and combinations thereof.

Further, the control logic of embodiments of the present disclosure may be embodied as non-transitory computer readable media on a computer readable medium containing executable program instructions executed by a processor, controller, or the like. Examples of computer readable media include, but are not limited to, ROM, RAM, compact disc (CD)-ROMs, magnetic tapes, floppy disks, flash drives, smart cards, and optical data storage devices. The computer readable medium can also be distributed in network coupled computer systems so that the computer readable media is stored and executed in a distributed fashion, e.g., by a telematics server or a Controller Area Network (CAN).

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of embodiments of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence, or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art and are not to be interpreted as having ideal or excessively formal meanings unless clearly defined as having such in the present application.

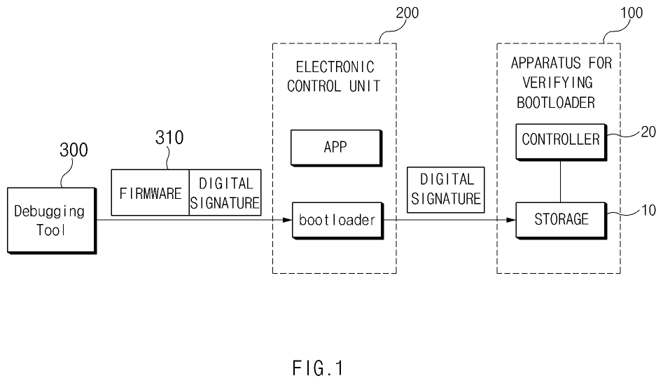

FIG. 1 is a configuration diagram of an apparatus for verifying a bootloader of an electronic control unit according to an exemplary embodiment of the present disclosure.

Referring to FIG. 1, an apparatus 100 for verifying a bootloader of an electronic control unit according to an exemplary embodiment of the present disclosure may include storage 10 and a controller 20. In this case, according to a method for implementing the apparatus 100 for verifying a bootloader of an electronic control unit according to an exemplary embodiment of the present disclosure, components may be combined with each other as one entity, or some components may be omitted.

In addition, an electronic control unit 200 may be various electronic control units (ECUs) provided in the vehicle and may include an application and a bootloader for driving the electronic control unit 200.

In addition, a debugging tool 300 may load firmware 310 to which digital signature is added into the electronic control unit 200 through a debugging port (e.g., Joint Test Action Group (JTAG)). Then, the electronic control unit 200 may transmit the digital signature of the firmware 310 to the verification apparatus 100. In this case, the debugging tool 300 may add the digital signature to the firmware based on a boot private key.

Meanwhile, referring to components of the verification apparatus 100, first, the storage 10 may store various logics, algorithms and programs required in the process of verifying the digital signature of the firmware received from the electronic control unit 200 when the electronic control unit 200 performs update of the firmware of the bootloader and changing an MAC (Message Authentication Code) for the bootloader of the electronic control unit 200 when a result of the verification for the digital signature of the firmware is normal.

The storage 10 may store various logics, algorithms and programs required in the process of verifying the digital signature of the firmware received from the electronic control unit 200 when the firmware to which the digital signature is added is loaded into the bootloader of the electronic control unit 200 and changing an MAC (Message Authentication Code) for the bootloader of the electronic control unit 200 when a result of the verification for the digital signature of the firmware is normal.

The storage 10 may store the MAC for the bootloader of the electronic control unit 200, which may be generated by the controller 20 as a boot MAC.

The storage 10 may store a boot public key for verifying the digital signature of the firmware.

The storage 10 may store information about the bootloader (e.g., size, start address, etc.).

The storage 10 may include at least one type of storage medium of memories such as a flash memory type memory, a hard disk type memory, a micro type memory, and a card type memory (e.g., an SD card (Secure Digital Card) or an XD card (eXtream Digital Card)), a RAM (Random Access Memory), an SRAM (Static RAM), a ROM (Read Only Memory), a PROM (Programmable ROM), a EEPROM (Electrically Erasable PROM), a MRAM (Magnetic RAM), and an optical disk type memory.

The controller 20 may perform overall control such that each of the above components normally performs its function. The controller 20 may be implemented in the form of hardware or software or may be implemented in a combination of hardware and software. Preferably, the controller 20 may be implemented with a microprocessor, but is not limited thereto

The controller 20 may perform a variety of control required in the process of verifying the digital signature of the firmware received from the electronic control unit 200 when the electronic control unit 200 performs update of the firmware of the bootloader and changing an MAC (Message Authentication Code) for the bootloader of the electronic control unit 200 when a result of the verification for the digital signature of the firmware is normal.

The controller 20 may perform a variety of control required in the process of verifying the digital signature of the firmware received from the electronic control unit 200 when the firmware to which the digital signature is added is loaded into the bootloader of the electronic control unit 200 and changing an MAC (Message Authentication Code) for the bootloader of the electronic control unit 200 when a result of the verification for the digital signature of the firmware is normal.

When verifying the digital signature of the firmware, the controller 20 may decrypt the digital signature based on the boot public key stored in the storage 10 to extract a hash value, compare the extracted hash value with a hash value stored in a header of the firmware (a hash value of the changed bootloader), and determine a normal state when the extracted hash value is equal to the stored hash value or determine an abnormal state when the extracted hash value is not equal to the stored hash value. In this case, the controller 20 may calculate the hash value for the bootloader by using the size and the start address as information about the bootloader.

When a result of the verification for the digital signature of the firmware is normal, the controller 20 may perform update from an MAC for the bootloader before the change (bootloader before firmware update), which is stored in the storage 10, to an MAC for the bootloader after the change (bootloader after firmware update). In this case, when the MAC for the bootloader before the change is maintained in the storage 10 because the result of the verification for the digital signature of the firmware is abnormal, the electronic control unit 200 does not operate normally because the MAC for the bootloader generated in a subsequent booting process is not identical to the MAC stored in the storage 10 (verification failure).

As a result, when the bootloader of the electronic control unit is updated using firmware having no digital signature, the electronic control unit 200 does not operate normally because the MAC stored in the storage 10 is not updated. This information may be provided to a user such that the user can respond to these situations.

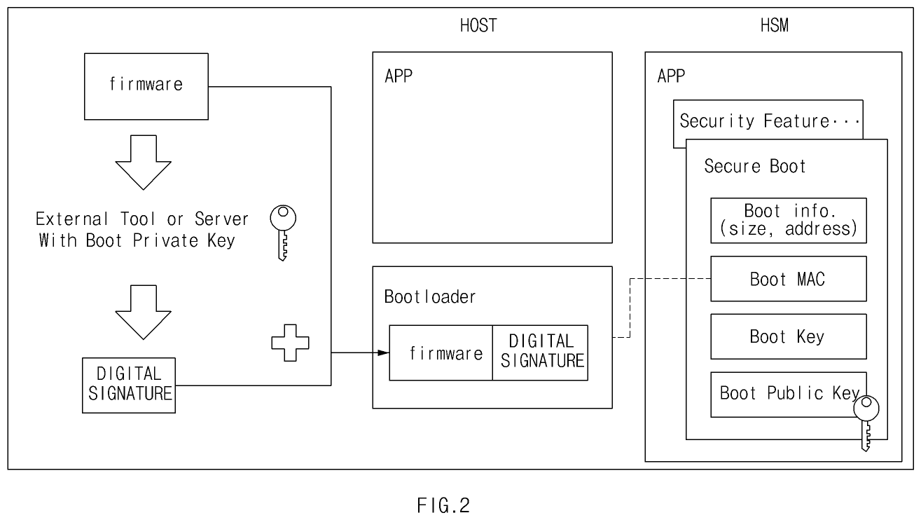

FIG. 2 is a diagram illustrating an example in which an apparatus for verifying a bootloader of an electronic control unit is implemented as a hardware security module (HSM) in the electronic control unit according to an exemplary embodiment of the present disclosure.

Referring to FIG. 2, the electronic control unit 200 may include a host and an HSM. The host may include an application and a bootloader for driving the electronic control unit 200 and the HSM may store various types of secure boot information. Here, the secure boot information may include information about the bootloader (e.g., size, start address, etc.), a boot MAC, a boot key, a boot public key, and the like.

The hardware security module (HSM) refers to a cryptographic processor specially designed for protection of the lifecycle of a cryptographic key, and may perform cryptographic processing, key protection, and key management within an enhanced anti-counterfeiting device. The HSM used in an electronic control unit domain may generally include a secure memory capable of safely storing a key. For example, the secure memory may include a highly secure HSM-dedicated RAM or ROM independent of a host system (e.g., an application), and the HSM may perform a series of operations through a dedicated central processing unit (CPU) to perform its functions relatively safely from the attack of potential attackers.

In particular, the HSM may provide a secure booting function of the electronic control unit. Secure booting is a function for verifying the integrity of the firmware of the electronic control unit in the case of booting through the HSM. Specifically, in the case of booting, the HSM may verify the integrity of a host bootloader, and transfer control to the host bootloader only when the integrity verification is passed. Therefore, only when the integrity of the bootloader is verified, the booting process of the host may proceed normally.

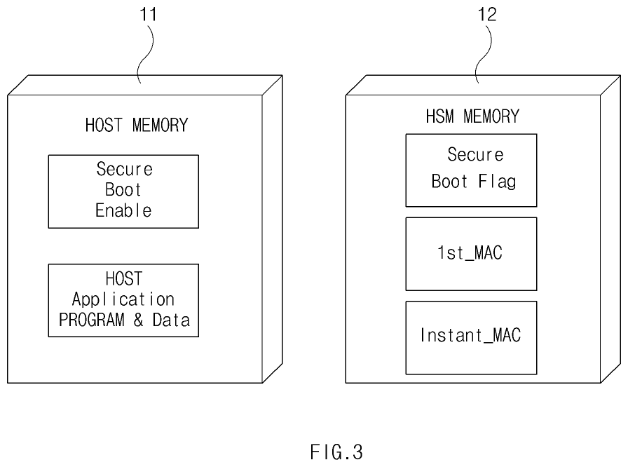

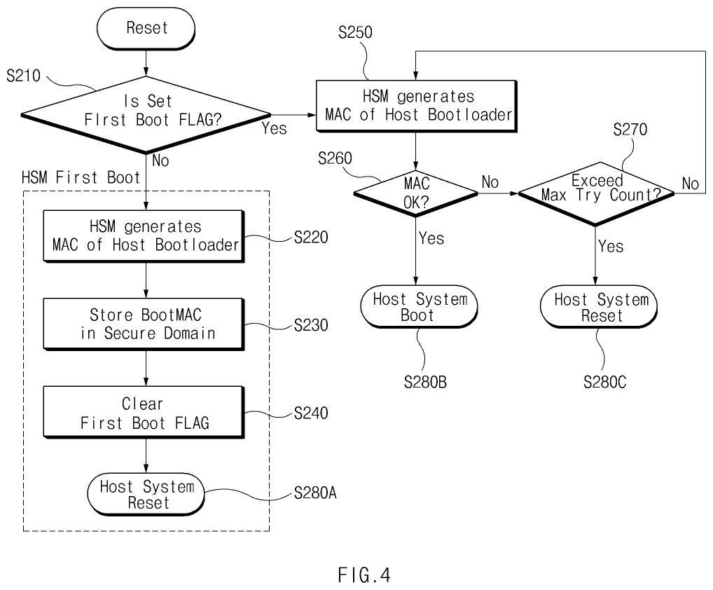

Hereinafter, the booting process of the host using the HSM will be described with reference to FIGS. 3 and 4 and [Table 1].

FIG. 3 shows an example of a memory configuration of an electronic control unit having an HSM according to an exemplary embodiment of the present disclosure, and FIG. 4 shows an example of a booting process of an electronic control unit having an HSM according to an exemplary embodiment of the present disclosure. In addition, [Table 1] shows the settings of the memory configuration shown in FIG. 3.

First, the electronic control unit 200 having the HSM may include at least a host memory 11 and an HSM memory 12. Here, the host memory 11 may store a secure boot setting (secure boot enable) indicating whether secure booting using the HSM is set, a host application program, data, and the like. In addition, the HSM memory 12 may store a secure boot flag (Secure Boot Flag), a first message authentication code (1st_MAC), an instant message authentication code (Instant_MAC), and the like.

Data stored in each of the memories 11 and 12 may be identified with different memory addresses, and at least some of the data may be set to have an area to be stored in each of the memories 11 and 12 in advance.

[Table 1] below shows examples of settings of an area in which data is to be stored, update, and access availability for each data to be stored in each of the memories 11 and 12.

TABLE 1

| | | Wired reprogramming | | | | | | |
|---|---|---|---|---|---|---|---|---|
| | Memory | By | By | Wireless | Memory access by | | Memory access by | |
| | areas for | general | security | reprogramming | host program | | HSM program | |
| Data type | storage | debugger | debugger | (by OTA) | Read | Write | Read | Write |
| Secure Boot enable | HOST | Write | Write | Write | Possible | Impossible | Impossible | Impossible |
| | NVM | Impossible | Impossible | Impossible | | | | |
| Secure Boot Flag | HSM | Write | Write | Write | Impossible | Impossible | Possible | Possible |
| | NVM | Impossible | Possible | Impossible | | | | |
| Host Application | HOST | Write | | Write | Possible | Possible | Possible | Possible |
| | NVM | Possible | | Possible | | | | |
| 1st_MAC | HSM | Write | | Write | Impossible | Impossible | Possible | Possible |
| | NVM | Impossible | | Impossible | | | | |
| Instant_MAC | HSM | — | — | — | Impossible | Impossible | Possible | Possible |
| | VM | | | | | | | |

In [Table 1], NVM means non-volatile memory, VM means volatile memory, and a secure debugger means a debugger with security. Hereinafter, each data will be described in detail.

Referring to [Table 1], the secure boot setting (Secure Boot Enable) may be set to ‘0’ or ‘1’, and when the secure boot setting is set to ‘0’, the secure boot phase is not performed in the electronic control unit 200, or when the secure boot setting is set to ‘1’, the secure boot phase may be performed. Once the secure boot setting is set to ‘1’, changing (writing) the data value from ‘1’ to ‘0’ is not necessarily allowed through any path.

A secure boot flag is a flag indicating whether a first message authentication code (1st_MAC) is generated during initial booting. This secure boot flag may have data integrity by blocking reading and writing through general paths such as general debuggers or over-the-air (OTA) updates.

A host application may refer to a general application data area in which reading and writing are possible via access through a certain path.

The first message authentication code may refer to an encryption authentication code generated (output) through a host application program and a unique encryption algorithm stored in the HSM with a unique key (Boot Key) value stored in the HSM as inputs.

The instant message authentication code may refer to a message authentication code generated through application data loaded in booting after the first message authentication code is generated at initial booting phase. The instant message authentication code may be used to determine the integrity of application data by comparison with the first message authentication code in secure boot phase to be described later.

Hereinafter, a secure boot phase will be described based on the data and memory settings for each data as described above, with reference to FIG. 3 and [Table 1]. In FIG. 4, it is assumed that the secure boot setting is set to ‘1’.

Referring to FIG. 4, a secure boot process is started because the secure boot setting is set to ‘1’. First, it may be determined whether a first boot flag is set in the HSM memory 12 (S210). When the first boot flag is set to ‘0’, it may indicate that the secure boot process is initially performed, and when the first boot flag is set to ‘1’, it may indicate that the secure boot process is not the first booting process.

When the first boot flag is set to ‘0’, the HSM may generate a first message authentication code using a host application program in the host memory and a unique key value stored in the HSM (S220).

The generated first message authentication code may be stored in a secure area of the HSM memory (S230).

As the first message authentication code is generated and stored, the first boot flag may be set to ‘1’ (S240), and the host system (electronic control unit) may be reset (S280A).

Because the secure boot process is started again by the reset of the host system, and the first boot flag in the HSM memory 12 is set to ‘1’ (No in S210), the HSM may generate an instant message authentication code using the host application program in the host memory 11 and the unique key value stored in the HSM (S250).

The HSM may compare the instant message authentication code with the first message authentication code stored in the secure area to determine whether the instant message authentication code is identical to the first message authentication code (S260).

When the instant message authentication code is identical to the first message authentication code as a result of the determination, the HSM may determine that there is no abnormality in the integrity of application data and boot the host system normally (S280B). When the instant message authentication code is not identical to the first message authentication code, the instant message authentication code is repeatedly generated and compared a preset number of times (S270).

When the integrity is not secured even through generation and comparison of the instant message authentication code have been repeated a preset number of times, the HSM may reset the host system (S280C).

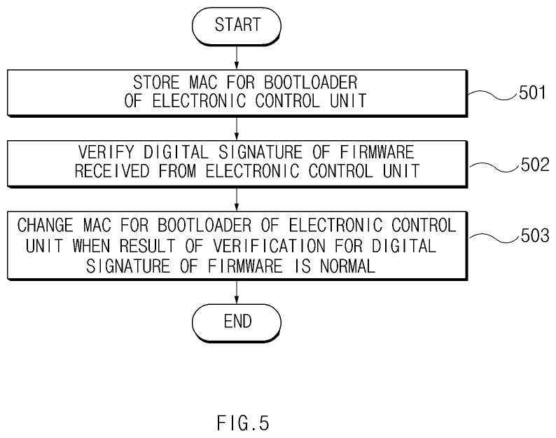

FIG. 5 is a detailed flowchart of a method for verifying a bootloader of an electronic control unit according to an exemplary embodiment of the present disclosure.

First, the storage 10 may store an MAC (Message Authentication Code) for a bootloader of the electronic control unit 200 (501).

Thereafter, the controller 20 may verify the digital signature of firmware received from the electronic control unit 200 (502).

Thereafter, when a result of the verification for the digital signature of the firmware is normal, the controller 20 may change the MAC for the bootloader of the electronic control unit 200 (503).

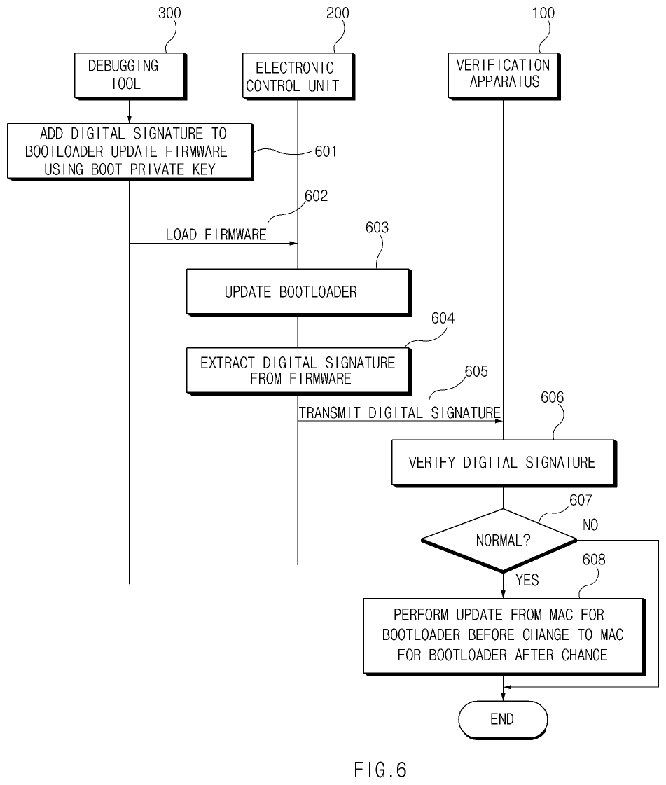

FIG. 6 is an overall flowchart of a method for verifying a bootloader of an electronic control unit according to an exemplary embodiment of the present disclosure.

First, the debugging tool 300 may add a digital signature to bootloader update firmware using a boot private key (601). In this case, the adding of the digital signature to the bootloader update firmware using the boot private key may be performed by a server or the other tool.

Thereafter, the debugging tool 300 may load the bootloader update firmware to which the digital signature is added into the electronic control unit 200 (602).

Thereafter, the electronic control unit 200 may update the bootloader using the firmware loaded by the debugging tool 300 (603).

In addition, the electronic control unit 200 may extract the digital signature from the firmware and transmit the digital signature to the verification apparatus 100 (604 and 605).

Thereafter, the verification apparatus 100 may verify the digital signature received from the electronic control unit 200 (606).

When a result of the verification is normal (607), the verification apparatus 100 may perform update from an MAC for the bootloader before the change (bootloader before firmware update), which is stored in the storage 10, to an MAC for the bootloader after the change (bootloader after firmware update) (608).

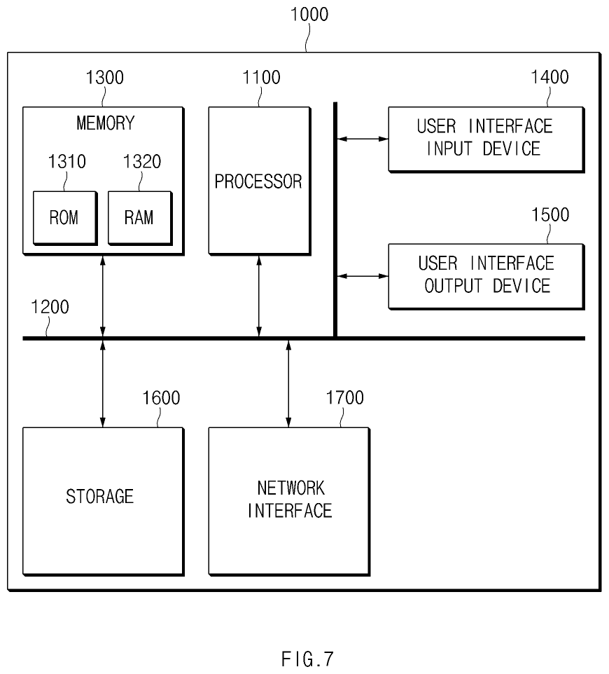

FIG. 7 is a diagram illustrating a computing system for performing a method for verifying a bootloader of an electronic control unit according to an exemplary embodiment of the present disclosure.

Referring to FIG. 7, the method for verifying a bootloader of an electronic control unit according to an exemplary embodiment of the present disclosure as described above may be also implemented through a computing system. A computing system 1000 may include at least one processor 1100, a memory 1300, a user interface input device 1400, a user interface output device 1500, storage 1600, and a network interface 1700, which are connected with each other via a system bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (e.g., the memory 1300 and/or the storage 1600) such as a RAM, a flash memory, a ROM, an EPROM, an EEPROM, a register, a hard disk, a solid state drive (SSD) a removable disk, and a CD-ROM. The exemplary storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of embodiments of the present disclosure, and various modifications and variations may be made without departing from the essential characteristics of embodiments of the present disclosure by those skilled in the art to which embodiments of the present disclosure pertains.

Therefore, the exemplary embodiments of the present disclosure are provided to explain the spirit and scope of embodiments of the present disclosure, but not to limit them, so that the spirit and scope of embodiments of the present disclosure is not limited by the embodiments. The scope of protection of embodiments of the present disclosure should be interpreted by the following claims, and all technical ideas within the scope equivalent thereto should be construed as being included in the scope of embodiments of the present disclosure.

As described above, the apparatus and method for verifying a bootloader of an electronic control unit may verify a digital signature of firmware received from the electronic control unit when the firmware to which the digital signature is added is loaded into the bootloader of the electronic control unit, and change an MAC (Message Authentication Code) for the bootloader of the electronic control unit when a result of the verification for the digital signature of the firmware is normal, enabling the electronic control unit to safely update the bootloader, as well as enabling normal booting even after the bootloader of the electronic control unit is updated.

Hereinabove, although embodiments of the present disclosure has been described with reference to exemplary embodiments and the accompanying drawings, embodiments of the present disclosure is not limited thereto, but may be variously modified and altered by those skilled in the art to which embodiments of the present disclosure pertains without departing from the spirit and scope of embodiments of the present disclosure claimed in the following claims.

What is claimed is:

1. An apparatus for verifying a bootloader of an electronic control unit comprising:
storage configured to store a message authentication code (MAC) for the bootloader of the electronic control unit; and
a controller configured to verify a digital signature of firmware received from the electronic control unit and change the MAC for the bootloader of the electronic control unit when a result of verification for the digital signature is normal.

2. The apparatus of claim 1, wherein the storage is further configured to store a boot public key for verifying the digital signature of the firmware and information about the bootloader.

3. The apparatus of claim 2, wherein the controller is further configured to decrypt the digital signature based on the boot public key to extract a first hash value, calculate a second hash value for the bootloader, and determine that the result of verification for the digital signature is normal when the first hash value is identical to the second hash value.

4. The apparatus of claim 3, wherein the controller is further configured to calculate the second hash value for the bootloader based on a size and a start address as the information about the bootloader.

5. The apparatus of claim 1, wherein the controller is further configured to perform update from the MAC for the bootloader before the change stored in the storage to the MAC for the bootloader after the change, when the result of verification for the digital signature is normal.

6. The apparatus of claim 1, wherein the controller is further configured to maintain the MAC for the bootloader before the change stored in the storage, when the result of verification for the digital signature is abnormal.

7. The apparatus of claim 1, wherein the controller is further configured to receive the digital signature of the firmware from the electronic control unit when the firmware is loaded into the electronic control unit by a debugging tool.

8. The apparatus of claim 7, wherein the debugging tool adds the digital signature to the firmware based on a boot private key.

9. The apparatus of claim 7, wherein the debugging tool is Joint Test Action Group (JTAG).

10. A method for verifying a bootloader of an electronic control unit comprising:
storing, by storage, a message authentication code (MAC) for the bootloader of the electronic control unit;
verifying, by a controller, a digital signature of firmware received from the electronic control unit; and
changing, by the controller, the MAC for the bootloader of the electronic control unit when a result of verification for the digital signature is normal.

11. The method of claim 10, further comprising:
storing, by the storage, a boot public key for verifying the digital signature of the firmware and information about the bootloader.

12. The method of claim 11, wherein the verifying of the digital signature of the firmware comprises:
decrypting the digital signature based on the boot public key to extract a first hash value;
calculating a second hash value for the bootloader; and
determining that the result of verification for the digital signature is normal when the first hash value is identical to the second hash value.

13. The method of claim 12, wherein the calculating of the second hash value comprises calculating the second hash value for the bootloader based on a size and a start address as the information about the bootloader.

14. The method of claim 10, wherein the changing of the MAC for the bootloader of the electronic control unit comprises:
performing update from the MAC for the bootloader before the change stored in the storage to the MAC for the bootloader after the change, when the result of verification for the digital signature is normal; and
maintaining the MAC for the bootloader before the change stored in the storage when the result of verification for the digital signature is abnormal.

15. The method of claim 10, wherein the verifying of the digital signature of the firmware comprises receiving the digital signature of the firmware from the electronic control unit when the firmware is loaded into the electronic control unit by a debugging tool.

16. The method of claim 15, wherein the receiving of the digital signature of the firmware comprises adding, by the debugging tool, the digital signature to the firmware based on a boot private key.
